(19) United States
(12) Patent Application Publication
(10) Pub. No.: US 2006/0043211 A1
(43) Pub. Date: Mar. 2, 2006

(54) System for cleaning and sanitizing

(76) Inventor: William R. Nelson, Poulsbo, WA (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 10/926,905

(22) Filed: Aug. 26, 2004

(51) Int. Cl. B05B 1/08

(52) U.S. Cl. 239/101

(57) ABSTRACT

The present invention provides a system (10) for cleaning and sanitizing surfaces that incorporates a high pressure fluid supply (52) and a low pressure fluid supply (42), often carrying an ozonated fluid, and alternates directed streams of the two fluids for application to contaminated surfaces through a single applicator (70, 100).

### TECHNICAL FIELD

The present invention relates generally to systems for supplying and dispersing high pressure fluid streams for cleaning surfaces, including food products and equipment used in food processing or preparation, and more specifically to an apparatus for cleaning and sanitizing surfaces by supplying a fluid containing ozone intermittently interposed in a high pressure water stream in such a fashion as to deliver ozonated water to a surface to be cleaned while minimizing the destruction of ozone by the high pressure water stream.

### BACKGROUND OF THE INVENTION

Many prior art U.S. patents disclose various and sundry apparatus and methods for the use of ozone in conjunction with a fluid for cleaning and sanitizing surfaces. Such patents include U.S. Pat. No. 5,236,512 to Rogers et al., U.S. Pat. No. 5,493,754 to Russell et al., U.S. Pat. No. 5,815,869 to Hopkins, U.S. Pat. No. 5,839,155 to Berglund et al., U.S. Pat. No. 6,115,862 to Cooper et al., U.S. Pat. No. 6,348,227 to Caracciolo, U.S. Pat. No. 6,455,017 to Kasting et al., U.S. Pat. No. 6,458,398 to Smith et al., and U.S. Pat. No. 6,638,364 to Harkins et al. Furthermore, U.S. Pat. Nos. 5,865,995 and 6,361,688, both to Nelson, teach systems for producing “ozonated water” by introducing ozone into water such that the gas is efficiently mixed with the liquid for application as a sanitizing fluid. Finally, U.S. patent application Ser. No. 10/755,527 filed Jan. 9, 2004 and entitled “Cleaning and Sanitizing System” discloses a system for delivery of an ozonated fluid stream in conjunction with a high pressure fluid stream.

The central object of many of the prior art patents disclosed herein above is the delivery of a high pressure cleaning water stream and an ozonated water stream to a surface to be sanitized. Since ozone is readily destroyed by pressurization beyond about 100 PSI, one difficulty of constructing such a system is delivering the ozonated water to the surface to be cleaned without destroying the ozone mixed therein which would thereby destroy the efficacy of the sanitizing fluid. The method of sanitizing surfaces disclosed in the '017 patent requires initially spraying a pressurized cleaning solution, including a detergent, onto the surface then rinsing the surface with a directed stream of ozonated water under substantially less pressure.

It is readily seen from the disclosures of the above-referenced prior art patents that cleaning and sanitizing using ozonated fluids is essentially a two-step process, requiring two applications of fluid, and usually requiring two sprayers or similar devices for applying the fluids. Accordingly, there is a need for a cleaning and sanitizing system that is capable of applying a high pressure cleaning stream in conjunction with an ozonated fluid without having a deleterious effect on the ozone and destroying the sanitizing properties imparted thereby. The invention disclosed in the above-referenced pending U.S. patent application Ser. No. 10/755,527 provides one such solution to this problem; the present invention provides a different solution.

### SUMMARY OF THE INVENTION

The present invention provides a system for cleaning and sanitizing surfaces that incorporates a high pressure water supply and a low pressure ozonated water supply and alternates directed streams of the two fluids for application to contaminated surfaces through a single applicator. The system of the present invention utilizes an ozone generator to supply ozone to an ozone mixer, for example the one described in U.S. Pat. No. 6,361,688 to Nelson, to generate an ozonated fluid. A high pressure pump is used to supply water or cleaning fluid at very high pressures, for example in the range of 1000 PSI to 3000 PSI via a supply line to a conventional spray wand having a trigger to initiate the spray application of fluid. Similarly, a supply line carrying ozonated water is also connected to the spray wand.

The ozonated water supply line incorporates a conventional mechanical check valve that permits ozonated water to flow into the spray wand, but prevents high pressure fluid from “backflowing” from the spray wand into the low pressure ozonated supply line. A solenoid-actuated shutoff valve is disposed in the high pressure fluid supply line to provide the ability to interrupt the supply of high pressure cleaning fluid thence permitting ozonated water to flow into the spray wand through the check valve.

The solenoid operated shutoff valve is alternately energized and de-energized so that while the valve is open, the check valve is closed, and vice-versa. This permits an alternating supply of high pressure cleaning fluid and then lower pressure ozonated water to be directed to and through the spray wand. Once the spray wand trigger is depressed, a stream of fluid that contains alternating pulses of high pressure cleaning fluid and ozonated water may be directed to the surface to be cleaned, with virtually no deleterious effect on the concentration of ozone in the ozonated water stream.

Therefore, one object of the present invention is a cleaning and sanitizing system utilizing ozone-enriched fluid as a sanitizing agent.

A further object of the invention is a cleaning and sanitizing system utilizing application of a high pressure cleaning fluid in conjunction with an ozone-enriched fluid.

A further object of the invention is a single step cleaning and sanitizing method incorporating both a high pressure cleaning fluid and an ozonated liquid.

A further object of the invention is a cleaning and sanitizing system capable of applying both a high pressure cleaning solution and an ozonated liquid in a single step, utilizing a single spray applicator.

A yet further object of the invention is a cleaning and sanitizing system that may deliver either cleaning fluid or sanitizing fluid separately when desired.

Further objects and advantages of the present invention will become apparent from the detailed description herein below, taken in conjunction with the drawing Figures described below.

### DESCRIPTION OF THE DRAWING FIGURES

Like reference numerals are used to indicate like parts throughout the drawing Figures:

FIG. 1 is a schematic diagram of a cleaning and sanitizing system in accordance with the present invention;

FIG. 2 is a schematic diagram of a cleaning and sanitizing system in accordance with the present invention; and

FIG. 3 is a schematic diagram of a cleaning and sanitizing system in accordance with the present invention; and

FIG. 4 is a schematic diagram of a cleaning and sanitizing system in accordance with the present invention

### DETAILED DESCRIPTION OF THE INVENTION

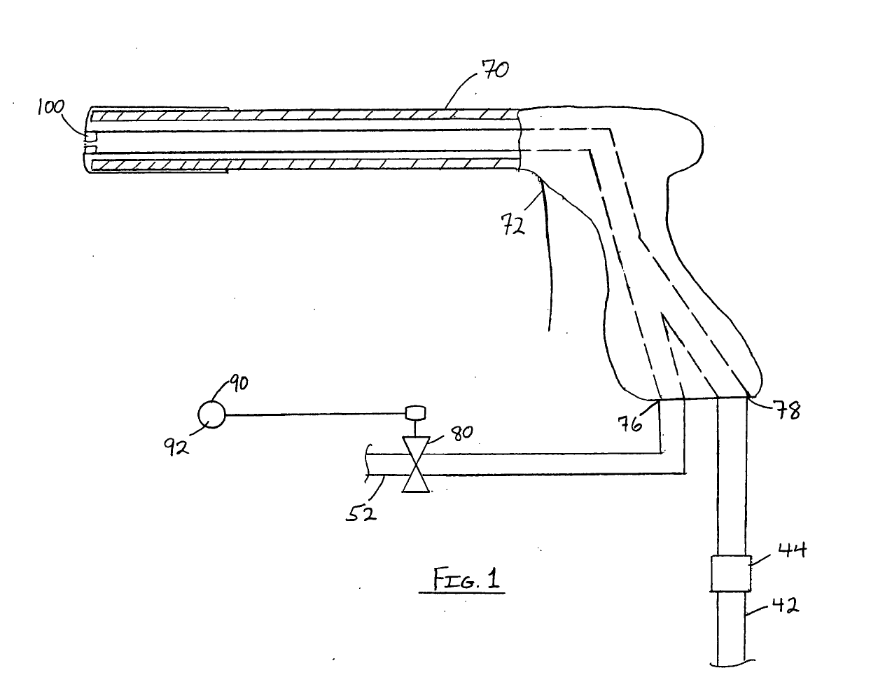

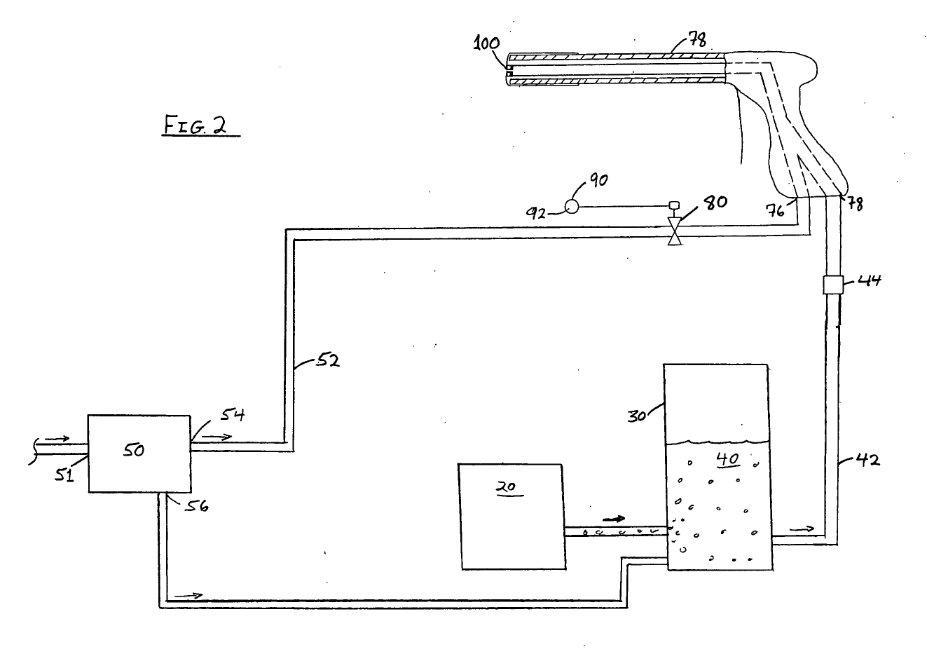

Referring now to drawing FIGS. 1 and 2, and in accordance with a preferred constructed embodiment of the present invention, an apparatus 10 for cleaning and sanitizing surfaces, for instance those found in environments such as food processing plants, includes an ozone generator 26 for producing ozone (O₃), an ozone mixer 30 for mixing the ozone with a fluid such as water to produce an ozonated fluid supply 40, and a high pressure pump 50 for generating a supply of a high pressure cleaning fluid, such as water. While water is typically used as a cleaning fluid, the present invention may be practiced with a wide variety of different cleaning fluids, such as detergent emulsions, steam, hot water, cold water, acid washes, chlorine dioxide, degreasers, etc.

The ozonated fluid supply 40 provides an ozone-enriched fluid via a first supply line 42 to a spray wand 70, having a conventional trigger-actuated valve 72 for initiating a directed spray of pressurized fluid through a nozzle 100 onto a target and both high and low pressure fluid inlet ports 76 and 78 respectively. As is well known to one of ordinary skill in the art, a wide variety of spray wands 70 may be used in conjunction with the instant invention, providing they are suitably equipped to tolerate the desired fluid pressures as discussed further herein below.

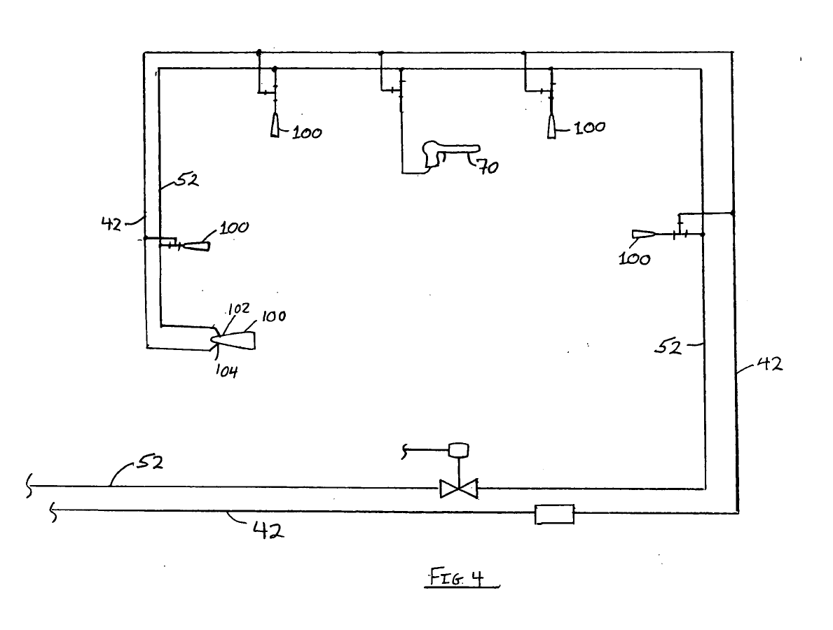

In an alternative embodiment of the present invention, a conventional spray wand 70 having a single inlet port 74 may be used. While the instant invention is particularly suited for use with a spray wand 70 wherein an operator may move around a contaminated environment to direct a cleaning and sanitizing spray on all surfaces, it should be noted that the invention may be practiced by replacing the spray wand 70 with a nozzle 100 having both high and low pressure inlet ports 102 and 104 as shown in FIG. 4. The nozzle 100, or a plurality thereof, may be fixed in a stationary position whereby articles to be cleaned and sanitized are conveyed past the nozzle 100. This embodiment of the invention is advantageous for use in meat processing plants and the like where animal carcasses are conveyed from slaughter to packaging. For ease of explication, the specification henceforth will refer to the use of a spray wand 70, but it should be understood that the invention may be readily practiced utilizing a nozzle 100 rather than spray wand 70. Furthermore, as seen in FIG. 4, a plurality of nozzles 100 or spray wands 70 may be positioned at various locations throughout a facility to facilitate the use of the cleaning and sanitizing system at a variety of locales throughout a plant or facility. This feature of the invention provides for tremendous economies of scale since the sources of high and low pressure fluid may be centrally located.

The ozonated fluid 40 is supplied to the low pressure inlet 78 of the spray wand 70 via a first supply line 42. Additionally, a check valve 44 is disposed in the first supply line 42 to prevent the flow of any pressurized fluid from the spray wand 70 into the ozonated fluid supply line 42, thereby inhibiting any undesirable over-pressurization of the ozonated fluid supply 40. In one embodiment of the present invention, the check valve 44 is disposed in the supply line 42 proximate the ozonated fluid supply 40, to reduce the weight in the line 42 and spray wand 70.

The high pressure cleaning fluid is supplied to the spray wand 70 via a second supply line 52. In an alternate embodiment of the present invention a check valve 44 may be disposed in the second supply line 52 to prevent the flow of any fluid from the spray wand 70 into the high pressure supply line. The check valves 44 of the present invention may be any commercially available check valve capable of operation with the pressure required in the high pressure supply line 52 as well as ozonated fluid, in accordance with the specific requirements of a given cleaning and sanitizing application. Valves, such as check valve 44, and fitting used in a line carrying ozonated water should be stainless steel to resist corrosion. The solenoid valve 80 used in the high pressure water line can be made of any suitable material rated for the desired pressure level. Solenoid coils operated in the range of 12 volts DC to 440 volts AC are readily available and may be selected according to the particular application.

The ozone generator 20 may be an existing ozone generator such as that disclosed in U.S. Pat. No. 6,361,688 to Nelson, or may be a yet to be developed ozone generator. The present invention may also be used by mixing some gas other than ozone with the low pressure fluid, wherein the ozone generator is simply replaced by a source of whatever gas is desired. However, for purposes of the present invention, the element 20 will be referred to as an ozone generator, although one of ordinary skill will recognize that a variety of gasses may be mixed with the low pressure fluid.

Additionally, the mixer 30 may be a liquid/gas-type mixer as disclosed and claimed in U.S. Pat. No. 6,361,688 to Nelson, although a wide variety of commercially available liquid/gas mixers can be employed to practice the system 10 in accordance with the instant invention.

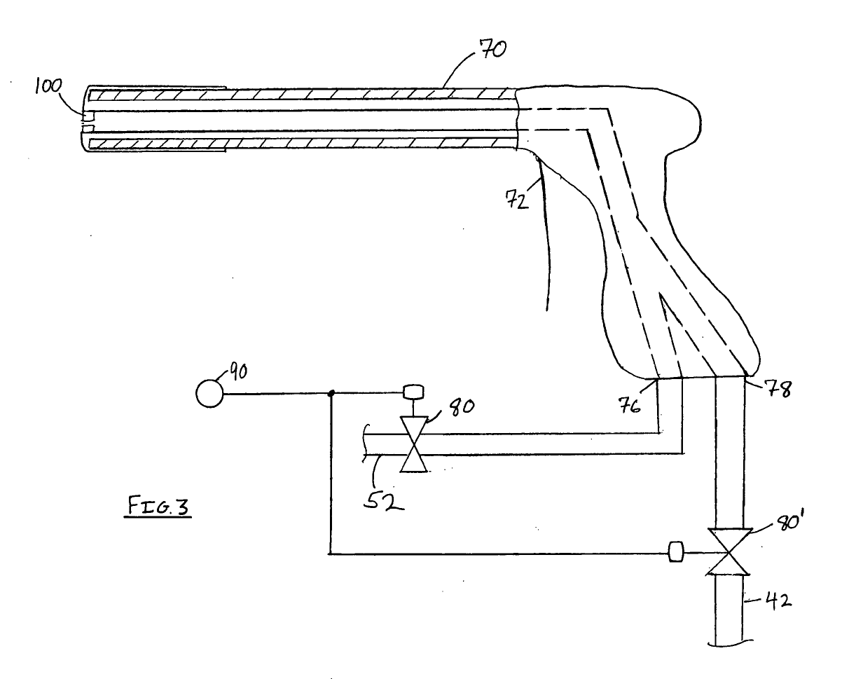

In one embodiment of the present invention as shown in FIG. 3, a solenoid operated control valve 80 is disposed in the second supply line 52, at a point upstream of the spray wand 70. The solenoid valve 80 is electrically connected to a pulse controller 90 having a rheostat control input 92 that alternately energizes (opens) and de-energizes (closes) the solenoid valve 80. The frequency of the opening and closing of the solenoid valve 80 may be readily controlled by simply changing the rheostat control input 92. This cycling (opening and closing) of the valve 80 permits a pulse of high pressure fluid to travel through the second supply line 52 thence into the spray wand 70 when the valve is energized (opened).

A wide variety of pulse controllers 90 are commercially available, for example variable electronic timer type rte-biaf20 manufactured by Idec Izumi Corp. In an alternative embodiment of the present invention, a microprocessor based controller, for example a programmable logic controller, having at least one output adapted to energize a solenoid may be used in place of the pulse controller 90. Furthermore, many conventional programmable logic controllers are capable of changing the frequency of the control valve 80 cycling responsive to an external input such as a rheostat, or alternatively, responsive to a software command. These programmable logic controllers are prevalent throughout modern automated factory floors and as such, are well-suited for use with the present invention.

As seen in FIG. 2, a pump 50 having a fluid inlet 51 and both high and low pressure outlets 54 and 56 respectively, may be used to supply both the high and low pressure water and thus pressurize both the first and second supply lines, 42 and 52 respectively. Alternatively, the system 10 of the instant invention may be practiced by employing separate pumps or other pressurization systems for the high and low pressure supply lines 42 and 52. The separate pressurization of the fluid supplies is particularly suited for applications where a high pressure cleaning fluid, such as a detergent emulsion or a degreaser is used in the high pressure portion of the system 10.

In operation, the pump 50 provides a constant source of high pressure fluid to the second supply line 52 and also a constant source of pressurization for the mixer 30 wherein the ozonated fluid supply 40 is created. The ozonated fluid is then forced into the supply line 42. It is necessary for the purposes of the present invention that the pressure in the second fluid supply line 52 be greater than the pressure in the first fluid supply line 42 so that when fluid is routed to the spray wand 70 the check valve 44 is forced closed, against the pressure in the line 42, thereby inhibiting the over-pressurization of the ozonated fluid.

The pulse controller 90 alternately energizes and de-energizes valve 80, thereby providing cyclical flow of high pressure cleaning solution through supply line 52 into the spray wand 70. Simultaneously, supply line 42 is charged with low-pressure ozonated fluid. When the trigger is depressed, the trigger actuated valve 72 opens and fluid flows through and out of spray wand 70.

While valve 80 remains open, high pressure cleaning solution flows into spray wand 70 to be delivered to a soiled surface. The high pressure solution forces check valve 44 closed, thereby inhibiting the flow of ozonated fluid into spray wand 70. When valve 80 closes, the pressure in the spray wand 70 drops to a point where the pressure in line 42 forces open check valve 44, thereby permitting the flow of ozonated fluid 40 into and through spray wand 70. Once valve 80 is energized, check valve 44 is again forced closed by the high pressure fluid, as previously discussed. In this fashion, the spray wand delivers alternating pulses of high and low pressure fluid as long as the trigger actuated valve 72 is open. A cycle rate of 2 per second with valve 80 being open and closed for equal amounts of time has been found to produce an acceptable result for certain sanitizing operations. Alternatively, the valve 80 may cycle at unequal open or closed durations or different diameter supply lines 42,52 may be used to control the relative amounts of high pressure fluid and ozonated fluid 40 to be delivered

When the spray wand 70 is not being used, as soon as valve 80 opens once, the pressure in the spray wand 70 remains sufficient to keep check valve 44 closed even while valve 80 continues to cycle, thereby preventing the over-pressurization of the ozonated fluid 40 and the concomitant destruction of the ozone gas contained therein.

It should be noted that by simply energizing valve 80 (opening the valve instead of cycling the valve) the system 10 may be used to deliver only the high pressure cleaning solution, rather than an alternating high and low pressure solution. Alternatively, by simply de-energizing valve 80, the system 10 will deliver only ozonated fluid 40 through the spray wand 70.

In an alternative embodiment of the present invention as seen in FIG. 3, a second solenoid actuated control valve 80′ may be disposed in the first supply line 42. In this embodiment of the invention, the valve 80 in the high pressure line 52 and the valve 80′ in the low pressure line 42 are energized at alternate times; i.e., when one is energized, the other is de-energized and vice-versa. This alternate operation of the two valves may be readily accomplished by providing electrical current to energize the valves 80, 80′ through two sets of complementary contacts on a conventional relay (not shown), one set being normally open and one set being normally closed. This embodiment of the invention provides alternating pulses of high and low pressure fluid to the spray wand 70 while obviating the need for check valve 44, since the low pressure valve will be closed while the high pressure valve is open.

In a yet further embodiment of the present invention, valve 80 (or valves 80, 80′) may be a self-actuating valve that is responsive to fluid flow or upstream pressure rather than a solenoid-actuated valve. In this embodiment of the invention, the valve 80 (or valves 80, 80′) opens and closes in response to pressure changes or mechanical end-of-stroke actuation according to principles that are well known in the fluid pressure handling art. For example, the valve 80 may be opened when the upstream pressure in supply line 52 exceeds a predetermined threshold, whereupon the high pressure fluid flows to spray wand 70. Valve 80 then closes when the upstream pressure in supply line 52 drops below the predetermined threshold. By cycling the pump 50 or other pressure supply to a pressure above and below the threshold, alternating pulses of high and low pressure fluid are delivered to spray wand 70.

The foregoing detailed description of the preferred embodiments of the invention is considered as illustrative only of the principles of the invention. Since the instant invention is susceptible of numerous changes and modifications by those of ordinary skill in the art, the invention is not limited to the exact construction and operation shown and described, and accordingly, all such suitable changes or modifications in structure or operation which may be resorted to are intended to fall within the scope of the claimed invention.

I claim:

1. A system for delivering alternating pulses of high and low pressure fluid to a target comprising:
a spray nozzle having a high pressure inlet, a low pressure inlet, and an outlet for directing a fluid stream;
a high pressure fluid supply line having a control valve therein for interrupting high pressure fluid flow therethrough, said high pressure fluid supply line connected to the high pressure inlet of said spray nozzle; and
a low pressure fluid supply line having a check valve therein to prevent reverse-fluid flow, said low pressure fluid supply line connected to the low pressure inlet of said spray nozzle.

2. The system for delivering alternating pulses of high and low pressure fluid to a target as claimed in claim 1 further comprising:
a pulse controller electrically connected to the control valve in said high pressure fluid supply line to cycle the control valve open and closed.

3. The system for delivering alternating pulses of high and low pressure fluid to a target as claimed in claim 2 wherein said pulse controller is a rheostat type controller.

4. The system for delivering alternating pulses of high and low pressure fluid to a target as claimed in claim 2 wherein said pulse controller is a programmable logic controller.

5. The system for delivering alternating pulses of high and low pressure fluid to a target as claimed in claim 1 further comprising:
a pump for pressurizing said high and low pressure fluid.

6. The system for delivering alternating pulses of high and low pressure fluid to a target as claimed in claim 1 further comprising:
an ozone generator for supplying ozone to an ozone mixer having an inlet and an outlet, wherein said low pressure fluid is supplied to said ozone mixer inlet and the ozone mixer outlet is connected to said low pressure fluid supply line.

7. The system for delivering alternating pulses of high and low pressure fluid to a target as claimed in claim 1 wherein said spray nozzle includes a spray wand having a trigger actuated valve for initiating fluid flow through said nozzle.

8. The system for delivering alternating pulses of high and low pressure fluid to a target as claimed in claim 1 wherein said control valve is a self-actuating valve responsive to pressure fluctuations of said high pressure fluid.

9. A system for delivering alternating pulses of high and low pressure fluid to a target comprising:
a spray nozzle having a high pressure inlet, a low pressure inlet, and an outlet for directing a fluid stream;
a high pressure fluid supply line having a control valve therein for interrupting high pressure fluid flow therethrough, said high pressure fluid supply line connected to the high pressure inlet of said spray nozzle; and
a low pressure fluid supply line having a control valve therein to for interrupting low pressure fluid flow therethrough, said low pressure fluid supply line connected to the low pressure inlet of said spray nozzle.

10. A system for delivering alternating pulses of high and low pressure fluid to a target as claimed in claim 9 further comprising:
a pulse controller electrically connected to the control valve in said high pressure fluid supply line and electrically connected to the control valve in said low pressure fluid supply line, wherein one control valve is energized open while the other valve remains closed and vice versa to supply alternating pulses of high and low pressure fluid to said nozzle.

11. The system for delivering alternating pulses of high and low pressure fluid to a target as claimed in claim 10 wherein said pulse controller is a rheostat type controller.

12. The system for delivering alternating pulses of high and low pressure fluid to a target as claimed in claim 10 wherein said pulse controller is a programmable logic controller.

13. The system for delivering alternating pulses of high and low pressure fluid to a target as claimed in claim 9 further comprising:
a pump for pressurizing said high and low pressure fluid.

14. The system for delivering alternating pulses of high and low pressure fluid to a target as claimed in claim 9 further comprising:
an ozone generator for supplying ozone to an ozone mixer having an inlet and an outlet, wherein said low pressure fluid is supplied to said ozone mixer inlet and the ozone mixer outlet is connected to said low pressure fluid supply line.

15. The system for delivering alternating pulses of high and low pressure fluid to a target as claimed in claim 9 wherein said spray nozzle includes a spray wand having a trigger actuated valve for initiating fluid flow through said nozzle.

16. A system for delivering alternating pulses of high and low pressure fluid to a target comprising:
a spray nozzle having a fluid inlet and an outlet for directing a fluid stream;
a high pressure fluid supply line having a control valve therein for interrupting high pressure fluid flow therethrough, said high pressure fluid supply line connected to the high pressure inlet of said spray nozzle; and
a low pressure fluid supply line having a check valve therein to prevent reverse-fluid flow, said low pressure fluid supply line connected to said high pressure fluid supply line at a point downstream of the check valve but upstream of the fluid inlet of said nozzle.

17. The system for delivering alternating pulses of high and low pressure fluid to a target as claimed in claim 16 further comprising:
a pulse controller electrically connected to the control valve in said high pressure fluid supply line to cycle the control valve open and closed.

18. The system for delivering alternating pulses of high and low pressure fluid to a target as claimed in claim 17 wherein said pulse controller is a rheostat type controller.

19. The system for delivering alternating pulses of high and low pressure fluid to a target as claimed in claim 17 wherein said pulse controller is a programmable logic controller.

20. The system for delivering alternating pulses of high and low pressure fluid to a target as claimed in claim 16 further comprising:
a pump for pressurizing said high and low pressure fluid.

21. The system for delivering alternating pulses of high and low pressure fluid to a target as claimed in claim 16 further comprising:
an ozone generator for supplying ozone to an ozone mixer having an inlet and an outlet, wherein said low pressure fluid is supplied to said ozone mixer inlet and the ozone mixer outlet is connected to said low pressure fluid supply line.

22. The system for delivering alternating pulses of high and low pressure fluid to a target as claimed in claim 16 wherein said spray nozzle includes a spray wand having a trigger actuated valve for initiating fluid flow through said nozzle.

23. The system for delivering alternating pulses of high and low pressure fluid to a target as claimed in claim 16 wherein said control valve is a self-actuating valve responsive to pressure fluctuations of said high pressure fluid.
